(19) United States
(12) Patent Application Publication
(10) Pub. No.: US 2017/0083298 A1
(43) Pub. Date: Mar. 23, 2017

(54) RESILIENT FORMAT FOR DISTRIBUTION OF AHEAD-OF-TIME COMPILED CODE COMPONENTS

(71) Applicant: Microsoft Technology Licensing, LLC, Redmond, WA (US)

(72) Inventors: Jan Kotas, Redmond, WA (US); Raja Krishnaswamy, Redmond, WA (US); Vance Morrison, Kirkland, WA (US)

(21) Appl. No.: 14/863,224

(22) Filed: Sep. 23, 2015

(51) Int. Cl. G06F 9/45

(52) U.S. Cl. CPC G06F 8/44

(57) ABSTRACT

Code components can be distributed as executable code (e.g., binaries) in a format that includes both machine-independent intermediate code (e.g., bytecode, CIL, etc.) and ahead-of-time compiled native code. The native code is executed if the execution environment is compatible with the native code. If the execution environment is incompatible with the native code, execution falls back to execution from intermediate code.

### BACKGROUND

A traditional static or ahead-of-time (AOT) software compiler converts source code written in a programming language into native code. Native code is executable code that is specific to the computing device on which the code will run. The ahead-of-time compiler is called ahead-of-time because the native code is produced, typically on a software development computer, before the program starts to run. Because compilation occurs before execution, runtime latencies associated with compilation are avoided. Runtime latencies are typically experienced by a user as a delay in the startup of the program. Similarly, AOT compilation does not deplete the resources of the device executing the machine code. Thus, in an unmanaged environment, at runtime, pre-existing native instructions are loaded into memory and are executed. The native (unmanaged) code produced by a traditional AOT compiler typically includes everything an operating system needs to run the code, but little else.

In contrast, in virtual machine (VM) environments (also referred to as “managed environments”) source code is compiled to an intermediate byte code representation that is not specific to any particular machine. Source code is typically compiled into machine-independent intermediate code (e.g., Sun Microsystem's JAVA bytecode, CIL (Common Intermediate Language) previously known as MSIL (Microsoft Intermediate Code), or LLVM bit code (low level virtual machine bit code, etc.) on a development computer. The intermediate code is copied onto a target device (the computer on which the intermediate code is executed). A dynamic compiler on the target computer compiles or interprets intermediate code as the program executes. That is, when the program is executed on the target device, the intermediate code is converted into native machine code “on the fly” (while the program executes) or is directly interpreted. Thus, in a managed environment, at runtime, the intermediate code can be translated into native binary instructions right before execution. That is, the intermediate code can be loaded into memory and compiled by a just-in-time (JIT) or on the fly compiler into machine-specific and runtime-specific instructions, which are then executed.

### SUMMARY

Code components can be distributed as executable code (e.g., binaries) in a format that includes both machine-independent intermediate code (e.g., bytecode, CIL, etc.) and ahead-of-time compiled native code. As used herein, a code component is an individually addressable unit (component) of a program, a part that can exist as a separate file (e.g., dlls, etc.). The native code is executed if the execution environment is compatible with the native code. If the execution environment is incompatible with the native code, execution falls back to execution from intermediate code.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1a illustrates a system 100 comprising a portion 100a that generates a format for an executable that enables native code to be distributed onto a target system in a format that includes both machine-independent intermediate code (e.g., bytecode, CIL, etc.) and ahead-of-time compiled native code. Alternatively, or in addition to portion 100a, system 100 can include a target system such as portion 100b that executes the native code when the execution environment of the target system is compatible with the native code and that falls back to execution of the intermediate code when the execution environment of the target system is incompatible with the native code in accordance with the subject matter described herein;

FIG. 1b illustrates another system 101 comprising a portion 100c that generates a format for an executable that enables native code to be distributed onto a target system in a format that includes both machine-independent intermediate code (e.g., bytecode, CIL, etc.) and ahead-of-time compiled native code. Alternatively, or in addition to portion 100c, system 101 can include a target system such as portion 100d that executes the native code when the execution environment of the target system is compatible with the native code and that falls back to execution of the intermediate code when the execution environment of the target system is incompatible with the native code in accordance with the subject matter described herein;

FIG. 2 illustrates an example of a method 200 for generating a format for an executable that enables native code to be distributed onto a target system in a format that includes both machine-independent intermediate code (e.g., bytecode, CIL, etc.) and ahead-of-time compiled native code and that enables execution of the native code when the execution environment of the target system is compatible with the native code and that falls back to execution of the intermediate code when the execution environment of the target system is incompatible with the native code in accordance with aspects of the subject matter disclosed herein;

FIG. 3 is a block diagram of an example of a computing environment in accordance with aspects of the subject matter disclosed herein; and

FIG. 4 is a block diagram of an example of an integrated development environment (IDE) in accordance with aspects of the subject matter disclosed herein.

### DETAILED DESCRIPTION

### Overview

When the output of compilation is intermediate language (IL), the intermediate language has to be converted to native code sometime before the code is run. Intermediate language is typically generated in a development environment and is copied onto a target device such as a user's (client) machine. Intermediate code is typically converted into machine-specific and runtime-specific native code on the target client machine.

Generating native code on the target device is associated with certain consequences. For example, for mobile devices, compilation into native code can take a relatively long time (e.g., minutes) and can consume significant amounts of battery power. The user typically experiences this consequence as a program startup delay. Another consequence of converting intermediate code into native code on a client machine is a possible decrease in the security of the software. That is, it may be advantageous for security reasons to be able to validate native code before it is run. For example, digitally signed software can be distributed. When the software is executed on the target device, the digital signature can be used to verify that the code is genuine. Digitally signing code on the device on which it is run poses opportunities for tampering.

Because there is no time at which compilation from intermediate code into native code can be performed without impacting performance, generation of native code is often delayed and/or is done in the background, introducing additional complexity and making testing more difficult. When the execution framework or execution engine (the “runtime”, for example, the implementation of a virtual machine environment) is updated, the native code may no longer work, forcing recompilation. Because the runtime is likely to be in use constantly, a reboot is typically needed to update the runtime, and only then can recompilation be initiated. This can be problematic in the case of devices such as but not limited to mobile devices such as a notebook which typically are either in use or turned off.

Attempts have been made to avoid or ameliorate the consequences described above. For example, Microsoft Corporation's Native Image Generator (Ngen.exe) is a tool that creates a native image for a program. A native image is a file comprising compiled processor-specific machine code for a program. Ngen.exe installs the native image for the program into the native image cache on the local (target) computer. A native image (native code executable) for a particular execution environment (e.g., for a particular set of code components) can be created. The runtime can use a native image from the cache instead of using the just-in-time (JIT) compiler for compilation. Another approach is to determine which parts of a program can be pre-compiled and which parts of a program have to be compiled on the target device and compiling the parts that can be pre-compiled before execution of the program begins. Another approach is to perform part of the compilation process ahead of time, and finish the compilation on the target device.

In accordance with aspects of the subject matter described herein, a new approach is introduced which avoids and/or ameliorates some or all of the consequences described above. In accordance with aspects of the subject matter described herein, an executable is generated on a development computer for each individually addressable unit (code component) making up an application or program and then the executable for each individual component is copied separately onto the target computer. A program is typically composed of multiple components which are compiled together into an executable. In accordance with aspects of the subject matter described herein, each individual component is compiled individually into a separate executable. All of the individual executables that make up an application are copied onto the target machine. Consequently, if a problem arises in one of the executables just that executable can be recompiled and copied over to the target machine.

One reason that a runtime can be incompatible with native code is because in some programming languages (e.g., in object oriented programming languages) a feature of the programming language enables a class to be changed. Changing the class can affect any other classes that use it. By detecting when there has been an incompatible change in the class, incompatibility between the execution environment and the native code can be detected.

When an incompatibility is detected when the program is executed, the native code is not used. Instead, the component is recompiled from the intermediate language on the target computer. The code that is distributed is directly executable. Moreover, by complying with a set of known versioning rules, executables can be updated independently of one another. The distributed code can include native code and conditions that can be checked at runtime to determine if the execution environment is compatible with the native code. The components have the list of conditions that have to be true in order to use the component. Suppose, for example, a component references a class. The file that includes the native code can include additional information that indicates that the code in the component is good only if the size of the class is 4 bytes. At runtime the condition is checked. It is expected that most of the time the condition will be satisfied and the pre-compiled code will be used. If the class has been modified and no longer has size of 4 bytes, the native code is not used and the component is recompiled on the fly on the target computer.

Other examples of an incompatibility between runtime and native code include changes to the type of fields of a base class (a base class has 2 fields and each of the fields has to be of type float but the runtime environment has two fields of type string) or changes to the methods the base class implements (the base class has been changed to override use of the method with another method). For example, suppose a program comprises part a and part b. Some of the information included in part a may get included in the pre-compiled version of part b. In accordance with aspects of the subject matter described herein, the information from part a that is included in b is kept track of in the compatibility indicators during compilation. When the program is executed, the compatibility indicators are examined. If the conditions still hold, the pre-compiled version of b is executed. Otherwise the part of the native code that is not compatible is not executed and execution falls back to JIT compilation. Suppose in part a a type T has 20 bytes. When part b is compiled, a dependency exists such that part b depends on type T being 20 bytes. If part a is changed, such that type T is changed to be 30 bytes, the part of part b that depends on type T being 20 bytes will not be used. Compatibility indicators capture this kind of information.

U.S. Pat. No. 8,959,495 “Unifying Static and Dynamic Compiler Optimizations in Source-Code Bases” issued Feb. 17, 2015 describes a technique for unifying static and dynamic compiler optimizations in source code bases. It is directed to making AOT compiled programs run faster. As described in the General Overview, column 2, line 64 to column 3, line 22, a host computer compiles source code of a target function to generate AOT compiled machine code. A second frontend compiler compiles the source code to generate a serialized intermediate representation (IR) from the source code. The IR can be used to optimize and compile code during runtime. An identifier can be used to mark a particular function of the program. The AOT compiled code corresponding to the marked portions are linked to the corresponding IR generated by the frontend compiler.

At program startup, the processor executes the machine code generated by the host compiler. During runtime, when an identifiable portion of the program should be JIT compiled, a VM such as a JIT compiler reads the corresponding portion from the serialized IR files. The system profiles the program to collect runtime information. The JIT compiler compiles the portion of the code using the runtime information to optimize the JIT compiled code. The JIT compiled code is patched to the AOT compiled code so that the processor executes the JIT compiled code instead of the AOT compiled code for the corresponding portion of the program. This approach differs from the approach described above in several ways including but not limited to the following: the identified portions of the program that will be JIT compiled are identified on the host computer that generates AOT compiled machine code at compile time, not at runtime. Furthermore, the entire program is compiled into a single executable instead of compiling each component individually as is described herein.

### Resilient Format for Distribution of Ahead-of-Time Compiled Code Components

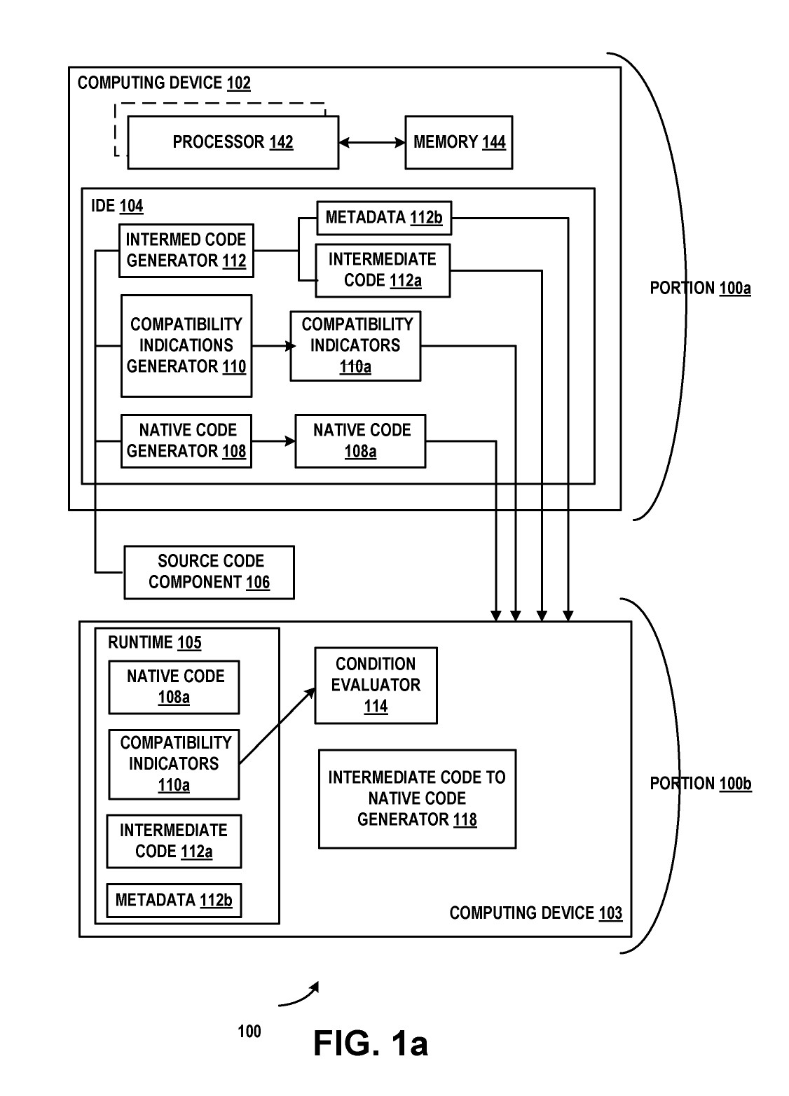

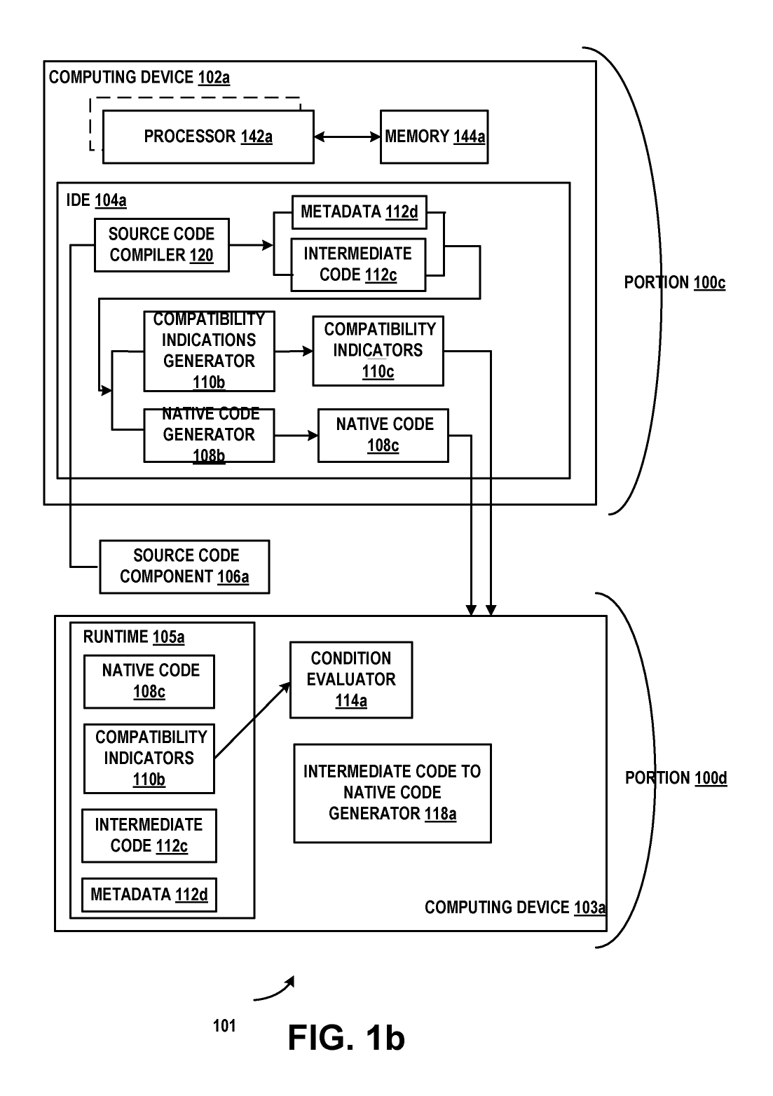

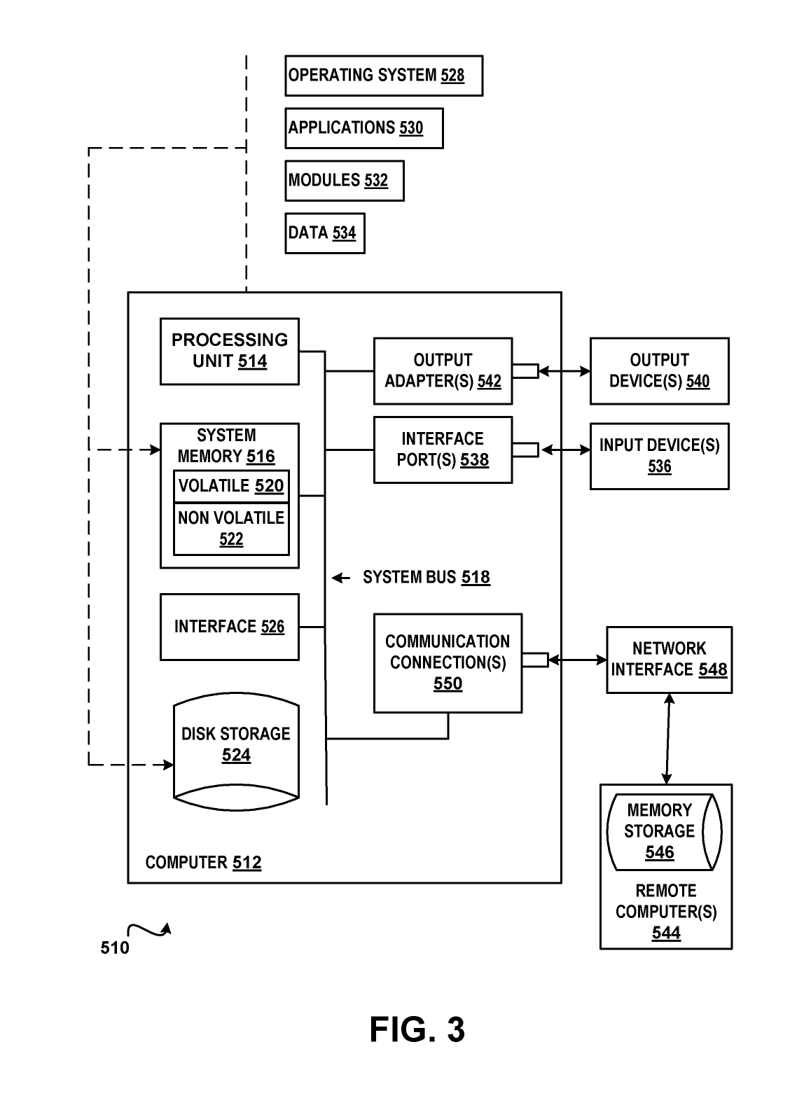

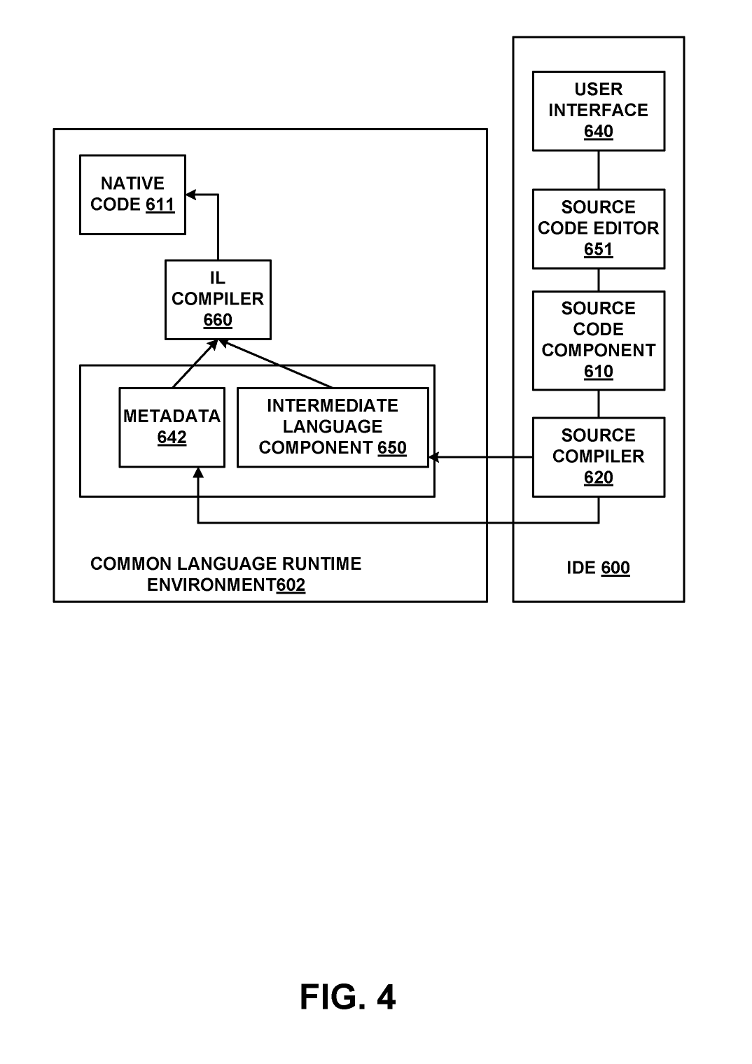

FIG. 1a illustrates an example of a system 100. System 100 can include a portion 100a that can generate an executable in a format that includes both machine-independent intermediate code (e.g., bytecode, CIL, etc.) and ahead-of-time compiled native code in accordance with the subject matter described herein. System 100 can include a portion 100b, instead of or in addition to portion 100a, that determines if the native code is compatible with the runtime and causes the native code to be executed when the execution environment of the target system is compatible with the native code and that causes fall back to execution of the intermediate code when the execution environment of the target system is incompatible with the native code. All or portions of system 100 may reside on one or more computers or computing devices such as the computers described below with respect to FIG. 3. System 100 may execute in whole or in part on a software development computer such as the software development computer described with respect to FIG. 4. System 100 or portions thereof may execute within an integrated development environment or IDE such as IDE 104 or may execute outside of an IDE. The IDE can be an IDE such as the one described with respect to FIG. 4 or can be any other IDE. All or portions of system 100 may be implemented as a plug-in or add-on. An IDE is a software application that typically provides comprehensive facilities to computer programmers for software development. System 100 or portions thereof can be a target computing device.

System 100 or portions thereof may include information obtained from a service (e.g., in the cloud) or may operate in a cloud computing environment. A cloud computing environment can be an environment in which computing services are not owned but are provided on demand. For example, information may reside on multiple devices in a networked cloud and/or data can be stored on multiple devices within the cloud.

System 100 can include one or more computing devices such as, for example, computing device 102 and/or computing device 103. Contemplated computing devices include but are not limited to desktop computers, tablet computers, laptop computers, notebook computers, personal digital assistants, smart phones, cellular telephones, mobile telephones, sensors, and so on. A computing device such as computing device 102 can include one or more processors such as processor 142, etc., and a memory such as memory 144 that communicates with the one or more processors. Computing device 102 and/or computing device 103 may be a device that operates in a constrained resource environment. A constrained memory environment is an environment in which the available resources are not sufficient to handle the demands with which it is faced using more traditional techniques of processing. A computing device such as computing device 103 can include one or more processors (not shown) and a memory (not shown) that communicates with the one or more processors. Computing device 102 and computing device 103 can be the same computing device. Computing device 102 and computing device 103 can be different computing devices.

System 100 may include several portions including but not limited to a portion such as portion 100a and/or a portion such as portion 100b. Portion 100a may include one or more program modules that when loaded into the memory 144 and accessed by the one or more processors such as processor 142, etc., cause the processor to perform the action or actions attributed to the one or more program modules. The one or more program modules (e.g., native code generator 108 and/or compatibilities generator 110) can generate a format for an executable that enables native code in a format that includes both machine-independent intermediate code (e.g., bytecode, CIL, etc.) and ahead-of-time compiled native code to be distributed onto a target system in accordance with the subject matter described herein.

Portion 100a can include a native code generator such as native code generator 108 that generates ahead-of-time compiled machine-specific native code such as a native code 108a. Native code generator 108 can be a static compiler for any programming language. The programming language of the source code converted into native code 108a can be an object-oriented programming language. The programming language in which the source code that is written that is converted into native code 108a can be a programming language that enables a mechanism of inheritance in which features of a base class are inherited by one or more child classes. Native code generator 108 can be a background or foreground compiler, pre-processor, parser, post-processor or any combination thereof. Native code generator 108 can be a code generator capable of working in an IDE. Native code generator 108 can be a code generator capable of working outside of an IDE. Native code generator 108 can receive one or more source code components such as source code component 106. As used herein, a source code component is an individually addressable unit of a program, a part that can exist as a separate file (e.g., dlls, etc.). Examples of code components of a program include but are not limited to functions and methods.

Portion 100a can include a compatibility indications generator such as compatibilities indications generator 110 that generates compatibility indicators such as compatibility indicators 110a. Compatibilities indications generator 110 can receive one or more source code components such as source code component 106. Compatibility indicators can include information concerning classes defined and referenced in the source code such as the number of fields in the class, methods, and so on. Compatibility indicators can include information that supports garbage collection (e.g., garbage collection information for the method so that what values in the registers and on the stack are pointers to the garbage collection heap when garbage collection is performed). Compatibility indicators can include information that enables an exception handler to be found when an exception is thrown. This information may enable garbage collection and exception handling given just the current instruction pointer within the native code.

Compatibility indicators can include information concerning the size of the instance for each type whose instances can be in the garbage collection heap and locations within the instance of any garbage collection references. Compatibility indicators can include information that describes a target method for virtual or interface methods that the type supports (e.g., a dispatch map). Compatibility indicators can include information that links together information in the metadata 112b with the corresponding native code structure. This enables the actual native code or type information corresponding to a metadata entry to be found. Compatibility indicators 110a can include tables (e.g., for types, methods, fields, etc.) and may have entries that point at variable-length values (e.g., method names, signature, method bodies, etc.).

Portion 100a can include an intermediate code generator such as intermediate code generator 112 that can generate machine-independent intermediate code such as intermediate code 112a. Portion 100a can include an intermediate code generator such as intermediate code generator 112 that can generate metadata such as metadata 112b. Intermediate code generator 112 can receive one or more source code components such as source code component 106. Metadata is a generic term for data that describes other data, where in this case, the described data is the source code or source code component. Thus the metadata can include information describing classes defined and referenced in the source code such as the number of fields in the class, methods, and so on. The native code 108a, the compatibility indicators 110a, the metadata 112b and the intermediate code 112a can be copied to the target computer, computing device 103. The native code 108a, the compatibility indicators 110a, the metadata 112b and the intermediate code 112a can be copied to the target computer, computing device 103 as a single file or as multiple files.

Portion 100b may include one or more program modules that when loaded into the memory (not shown) and accessed by the one or more processors (not shown) cause the processor to perform the action or actions attributed to the one or more program modules. The one or more program modules (e.g., a condition evaluator such as condition evaluator 114) can determine if the runtime such as runtime 105 is compatible with native code such as native code 108a. Portion 100b can include native code 108a, compatibility indicators 110a intermediate code 112a and metadata 112b. Portion 100b can include an intermediate code to native code generator such as intermediate code to native code generator 118. The intermediate code to native code generator 118 can be a dynamic compiler or a JIT compiler. The intermediate code to native code generator 118 can be replaced by an intermediate code interpreter (not shown).

If the condition evaluator 114 determines that the runtime 105 is compatible with native code 108a, native code 108a, the condition evaluator 114 can cause native code 108a to be executed. If the condition evaluator 114 determines that the runtime 105 is incompatible with native code 108a, the condition evaluator 114 can cause the intermediate code to native code generator 118 to generate native code (not shown) from intermediate code 112a on the fly. Intermediate code to native code generator 118 can execute the generated native code. Portion 100b can receive one or more executables from portion 100a in a one or more files in a format that includes both machine-independent intermediate code (e.g., bytecode, CIL, etc.) and ahead-of-time compiled native code. Compatibility indicators and/or metadata may also be included.

FIG. 1b illustrates an example of a system 101. System 101 can include a portion 100c that can generate an executable in a format that includes both machine-independent intermediate code (e.g., bytecode, CIL, etc.) and ahead-of-time compiled native code in accordance with the subject matter described herein. System 101 can include a portion 100d, instead of or in addition to portion 100c, that determines if the native code is compatible with the runtime and causes the native code to be executed when the execution environment of the target system is compatible with the native code and that causes fall back to execution of the intermediate code when the execution environment of the target system is incompatible with the native code. All or portions of system 101 may reside on one or more computers or computing devices such as the computers described below with respect to FIG. 3. System 101 may execute in whole or in part on a software development computer such as the software development computer described with respect to FIG. 4. System 101 or portions thereof may execute within an integrated development environment or IDE such as IDE 104a or may execute outside of an IDE. The IDE can be an IDE such as the one described with respect to FIG. 4 or can be any other IDE. All or portions of system 101 may be implemented as a plug-in or add-on. An IDE is a software application that typically provides comprehensive facilities to computer programmers for software development. System 101 or portions thereof can be a target computing device.

System 101 or portions thereof may include information obtained from a service (e.g., in the cloud) or may operate in a cloud computing environment. A cloud computing environment can be an environment in which computing services are not owned but are provided on demand. For example, information may reside on multiple devices in a networked cloud and/or data can be stored on multiple devices within the cloud.

System 101 can include one or more computing devices such as, for example, computing device 102a and/or computing device 103a. Contemplated computing devices include but are not limited to desktop computers, tablet computers, laptop computers, notebook computers, personal digital assistants, smart phones, cellular telephones, mobile telephones, sensors, and so on. A computing device such as computing device 102a can include one or more processors such as processor 142a, etc., and a memory such as memory 144a that communicates with the one or more processors. Computing device 102a and/or computing device 103a may be a device that operates in a constrained resource environment. A computing device such as computing device 103a can include one or more processors (not shown) and a memory (not shown) that communicates with the one or more processors. Computing device 102a and computing device 103a can be the same computing device. Computing device 102a and computing device 103a can be different computing devices.

System 101 may include several portions including but not limited to a portion such as portion 100c and/or a portion such as portion 100d. Portion 100c may include one or more program modules that when loaded into the memory 144a and accessed by the one or more processors such as processor 142a, etc., cause the processor to perform the action or actions attributed to the one or more program modules. The one or more program modules (e.g., source code compiler 120, native code generator 108b and/or compatibilities generator 110b) can generate a format for an executable that enables native code in a format that includes both machine-independent intermediate code (e.g., bytecode, CIL, etc.) and ahead-of-time compiled native code to be distributed onto a target system in accordance with the subject matter described herein.

Portion 100c can include a native code generator such as native code generator 108b that generates ahead-of-time compiled machine-specific native code such as a native code 108c. Native code generator 108b can be a static compiler for any programming language. The programming language of the source code converted into native code 108c can be an object-oriented programming language. The programming language in which the source code that is written that is converted into native code 108c can be a programming language that enables a mechanism of inheritance in which features of a base class are inherited by one or more child classes. Native code generator 108b can be a background or foreground compiler, pre-processor, parser, post-processor or any combination thereof. Native code generator 108b can be a code generator capable of working in an IDE. Native code generator 108b can be a code generator capable of working outside of an IDE. Native code generator 108b can receive metadata such as metadata 112d and intermediate code such as intermediate code 112c from which native code generator 108b generates native code 108c.

Portion 100c can include a compatibility indications generator such as compatibilities indications generator 110b that generates compatibility indicators such as compatibility indicators 110c. Compatibilities indications generator 110b can receive metadata such as metadata 112d and intermediate code such as intermediate code 112c from which compatibilities indications generator 110b generates compatibility indicators 110c. Compatibility indicators can include information concerning classes defined and referenced in the source code such as the number of fields in the class, methods, and so on. Compatibility indicators can include information that supports garbage collection (e.g., garbage collection information for the method so that what values in the registers and on the stack are pointers to the garbage collection heap when garbage collection is performed). Compatibility indicators can include information that enables an exception handler to be found when an exception is thrown. This information may enable garbage collection and exception handling given just the current instruction pointer within the native code.

Compatibility indicators can include information concerning the size of the instance for each type whose instances can be in the garbage collection heap and locations within the instance of any garbage collection references. Compatibility indicators can include information that describes a target method for virtual or interface methods that the type supports (e.g., a dispatch map). Compatibility indicators can include information that links together information in the metadata 112d with the corresponding native code structure. This enables the actual native code or type information corresponding to a metadata entry to be found. Compatibility indicators 110c can include tables (e.g., for types, methods, fields, etc.) and may have entries that point at variable-length values (e.g., method names, signature, method bodies, etc.)

Portion 100c can include an intermediate code generator such as source code compiler 120 that can generate machine-independent intermediate code such as intermediate code 112c. Portion 100c can include an intermediate code generator such as source code compiler 120 that can generate metadata such as metadata 112d. Metadata is a generic term for data that describes other data, where in this case, the described data is the source code or source code component. Thus the metadata can include information describing classes defined and referenced in the source code such as the number of fields in the class, methods, and so on. Source code compiler 120 can receive one or more source code components such as source code component 106a. As used herein, a source code component is an individually addressable unit of a program, a part that can exist as a separate file (e.g., dlls, etc.). Examples of code components of a program include but are not limited to functions and methods. The native code 108c, the compatibility indicators 110c, the metadata 112c and the intermediate code 112c can be copied to the target computer, computing device 103a. The native code 108c, the compatibility indicators 110c, the metadata 112d and the intermediate code 112c can be copied to the target computer, computing device 103 as a single file or as multiple files.

Portion 100d may include one or more program modules that when loaded into the memory (not shown) and accessed by the one or more processors (not shown) cause the processor to perform the action or actions attributed to the one or more program modules. The one or more program modules (e.g., a condition evaluator such as condition evaluator 114a) can determine if the runtime such as runtime 105a is compatible with native code such as native code 108c. Portion 100d can include native code 108c, compatibility indicators 110b, intermediate code 112c and metadata 112d. Native code 108c, compatibility indicators 110b, intermediate code 112c and metadata 112d can be received by portion 100d from portion 100c. Portion 100d can include an intermediate code to native code generator such as intermediate code to native code generator 118a. The intermediate code to native code generator 118a can be a dynamic compiler or a JIT-compiler. The intermediate code to native code generator 118a can be replaced or augmented by an intermediate code interpreter (not shown).

If the condition evaluator 114a determines that the runtime 105a is compatible with native code 108c, the condition evaluator 114a can cause native code 108c to be executed. If the condition evaluator 114a determines that the runtime 105a is incompatible with native code 108c, the condition evaluator 114a can cause the intermediate code to native code generator 118a to generate native code (not shown) from intermediate code 112c on the fly. Intermediate code to native code generator 118a can execute the generated native code. Portion 100d can receive one or more executables from portion 100c in one or more files in a format that includes both machine-independent intermediate code (e.g., bytecode, CIL, etc.) and ahead-of-time compiled native code, as described more fully above. Compatibility indicators and/or metadata may also be included.

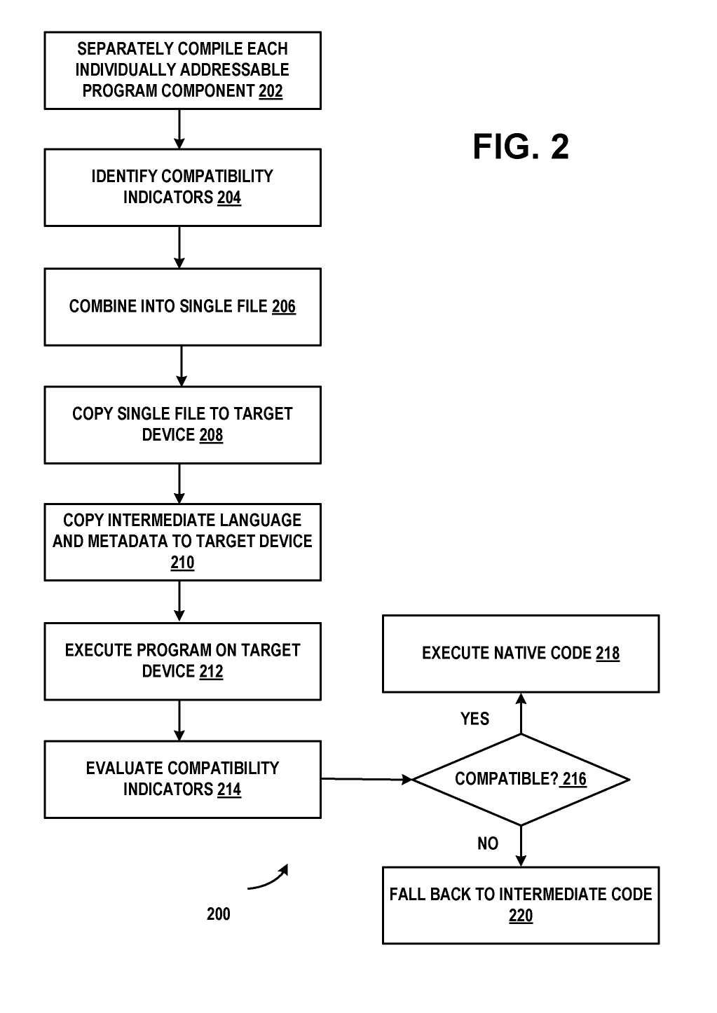

FIG. 2 illustrates an example of a method 200 for generating a format for an executable that enables native code to be distributed onto a target system and that enables execution of the native code when the execution environment of the target system is compatible with the native code and that falls back to execution of the intermediate code when the execution environment of the target system is incompatible with the native code in accordance with aspects of the subject matter disclosed herein. The method described in FIG. 2 can be practiced by a system such as but not limited to the ones described with respect to FIGS. 1a and 1b. While method 200 describes a series of operations that are performed in a sequence, it is to be understood that method 200 is not limited by the order of the sequence depicted. For instance, some operations may occur in a different order than that described. In addition, one operation may occur concurrently with another operation. In some instances, not all operations described are performed. In some instances, not all operations performed are illustrated.

At operation 202 on a software development computing device, an individually addressable component of a program can be separately compiled into machine-specific unmanaged native code. At operation 204 conditions can be identified that enable compatibility between runtime and native code to be determined. Intermediate code and metadata can be generated. At operation 206 native code and the identified conditions can be combined into a single file. Intermediate code and metadata can be included in the file. At operation 208 the file including the compatibility indicators and the native code can be copied to a target computing device. At operation 210 intermediate code and metadata for the individually addressable component of a program can be copied to the target computing device. At operation 212 on the target device, execution of the individually addressable component of a program can begin. At operation 214 the compatibility conditions can be evaluated for compatibility between the runtime and the native code. At operation 216 in response to determining that the runtime and the native code are compatible, the native code can be executed at operation 218. At operation 216 in response to determining that the runtime and the native code are incompatible, execution can fall back to dynamic generation of native code from intermediate code at operation 220.

### Example of a Suitable Computing Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a graphics processing unit (GPU). The instructions can be instructions for implementing functionality carried out by one or more components or modules discussed above or instructions for implementing one or more of the methods described above. Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer readable media may be implemented in any method or technology for storage of information such as computer readable instructions, data structures, program modules or other data. Computer readable media include computer-readable storage media (also referred to as computer storage media) and communications media. Computer storage media includes physical (tangible) media, such as but not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices that can store the desired data and which can be accessed by computer 512. Communications media include media such as, but not limited to, communications signals, modulated carrier waves or any other intangible media which can be used to communicate the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, voice recognition and gesture recognition systems and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

FIG. 4 illustrates an integrated development environment (IDE) 600 and Common Language Runtime Environment 602. An IDE 600 may allow a user (e.g., developer, programmer, designer, coder, etc.) to design, code, compile, test, run, edit, debug or build a program, set of programs, web sites, web applications, and web services in a computer system. Software programs can include source code (component 610), created in one or more source code languages (e.g., Visual Basic, Visual J#, C++. C#, J#, Java Script, APL, COBOL, Pascal, Eiffel, Haskell, ML, Oberon, Perl, Python, Scheme, Smalltalk and the like). The IDE 600 may provide a native code development environment or may provide a managed code development that runs on a virtual machine or may provide a combination thereof. The IDE 600 may provide a managed code development environment using the .NET framework. An intermediate language component 650 may be created from the source code component 610 and the native code component 611 using a language specific source compiler 620 and the native code component 611 (e.g., machine executable instructions) is created from the intermediate language component 650 using the intermediate language compiler 660 (e.g. just-in-time (JIT) compiler), when the application is executed. That is, when an IL application is executed, it is compiled while being executed into the appropriate machine language for the platform it is being executed on, thereby making code portable across several platforms. Alternatively, in other embodiments, programs may be compiled to native code machine language (not shown) appropriate for its intended platform.

A user can create and/or edit the source code component according to known software programming techniques and the specific logical and syntactical rules associated with a particular source language via a user interface 640 and a source code editor 651 in the IDE 600. Thereafter, the source code component 610 can be compiled via a source compiler 620, whereby an intermediate language representation of the program may be created, such as assembly 630. The assembly 630 may comprise the intermediate language component 650 and metadata 642. Application designs may be able to be validated before deployment.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
at least one processor:
a memory connected to the at least one processor; and
at least one program module that when loaded into the memory causes the at least one processor to:
generate separate machine-specific native code for an individually addressable program component; and
determine compatibility indicators that enable determination of compatibility between a runtime of a target computing device and the native code.

2. The system of claim 1, further comprising:
at least one program module that when loaded into the memory causes the at least one processor to:
copy the machine-specific native code for the individually addressable program component and the compatibility indicators that determine compatibility between the runtime and the native code to the target computing device.

3. The system of claim 1, wherein the individually addressable program component is written in an object-oriented language.

4. The system of claim 1, wherein the individually addressable program component is written in a programming language that supports inheritance.

5. The system of claim 1, wherein the compatibility indicators include garbage collection information.

6. The system of claim 1, wherein the compatibility indicators include exception handling information.

7. The system of claim 1, wherein the compatibility indicators include information about a class referenced in the individually addressable program component.

8. A method comprising:
performing by at least one processor of a computing device comprising a target computing device:
receiving native code for an individually addressable program component;
receiving indicators that determine compatibility between the native code and a runtime of the target computing device; and
evaluating the compatibility indicators.

9. The method of claim 8, further comprising:
in response to determining that the native code and the runtime are compatible, executing the native code.

10. The method of claim 8, further comprising:
in response to determining that the native code and the runtime are incompatible, generating native code from intermediate code for the individually addressable program component and executing the native code generated from the intermediate code during program execution.

11. The method of claim 8, further comprising:
determining that the native code and the runtime are incompatible by detecting an incompatible change in a class referenced in the individually addressable program component.

12. The method of claim 8, further comprising:
determining that the native code and the runtime are compatible by detecting no incompatible changes in a class referenced in the individually addressable program component.

13. The method of claim 8, further comprising;
updating a single executable, independently of another executable.

14. A system comprising:
at least one processor:
a memory connected to the at least one processor of a computing node; and
at least one program module that when loaded into the memory causes the at least one processor to:
receive native code for an individually addressable program component;
receive indicators that determine compatibility between the native code and a runtime of the target computing device; and
evaluate the compatibility indicators.

15. The system of claim 14, further comprising:
at least one program module that when loaded into the memory causes the at least one processor to:
execute the native code in response to determining that the native code and the runtime are compatible.

16. The system of claim 14, further comprising:
at least one program module that when loaded into the memory causes the at least one processor to:
generate native code from intermediate code for the individually addressable program component and execute the native code generated from the intermediate code during program execution in response to determining that the native code and the runtime are incompatible.

17. The system of claim 14, further comprising:
at least one program module that when loaded into the memory causes the at least one processor to:
detect compatibility between the runtime of the target device and the native code by detecting no incompatible changes in a base class or in a component that inherits from the base class.

18. The system of claim 14, further comprising:
at least one program module that when loaded into the memory causes the at least one processor to:
execute the native code in response to determining that the runtime of the target device and the native code are compatible.

19. The system of claim 14, further comprising:
at least one program module that when loaded into the memory causes the at least one processor to:
generate native code from the intermediate code for the individually addressable program component during execution of the program in response to determining that the runtime of the target device and the native code are incompatible;
execute the native code generated from the intermediate code.

20. The system of claim 14, further comprising:
at least one program module that when loaded into the memory causes the at least one processor to:
generate compatibility indicators comprising information concerning methods or fields of a base class.
